(19) United States
(12) Patent Application Publication
(10) Pub. No.: US 2015/0061179 A1
(43) Pub. Date: Mar. 5, 2015

(54) CERAMIC DIE PIN FOR MOLTEN PLASTIC EXTRUSION

(71) Applicant: GRAHAM PACKAGING COMPANY, L.P., York, PA (US)

(72) Inventors: Edward A. Hoffman, Birdsboro, PA (US); Larry M. Taylor, Landisville, PA (US); Gannon T. Kupko, Lewisberry, PA (US)

(73) Assignee: GRAHAM PACKAGING COMPANY, L.P., York, PA (US)

(21) Appl. No.: 14/455,255

(22) Filed: Aug. 8, 2014

Related U.S. Application Data
(60) Provisional application No. 61/872,332, filed on Aug. 30, 2013.

(51) Int. Cl. B29C 47/78; B29D 23/00; B29C 47/20

(52) U.S. Cl. CPC B29C 47/78; B29C 47/20; B29D 23/00; B29K 2101/00
USPC 264/209.1; 425/381

(57) ABSTRACT

Ceramic die pin for molten thermoplastic extrusion, apparatus for molten thermoplastic extrusion including a ceramic die pin, and methods of molten thermoplastic extrusion with a ceramic die pin. The ceramic head member can have a mounting cavity formed therein. The ceramic head member can be made of high purity aluminum oxide, and have an outer surface finish of between about 4 RMS and about 275 RMS.

### CROSS-REFERENCE TO RELATED APPLICATION

This application claims priority to U.S. Provisional Patent Application Ser. No. 61/872,332, filed Aug. 30, 2013, which is incorporated by reference herein in its entirety.

### FIELD OF THE INVENTION

The disclosed subject matter is related to apparatus and methods for the extrusion of molten plastic material, and particularly to die pins for the same.

### BACKGROUND OF THE INVENTION

Molten thermoplastic extrusion is widely employed for the manufacture of plastic articles, including plastic containers and the like. Generally, plastic polymer pellets are melted within a heated extrusion apparatus under pressure and extruded through an outlet. In certain circumstances, the molten plastic or extrudate is extruded in the form of a tube or other hollow member, such as for blow molding techniques. For example, molten plastic is extruded from the extrusion apparatus in an annular space defined between an outlet and a tooling or die pin disposed within the outlet to shape the molten plastic into a hollow parison.

Die pins for extrusion of molten plastic for container blow molding are conventionally made of tool steel. However, steel die pins are susceptible to the accumulation of degraded molten plastic during repeated cycles of plastic extrusion. In rare instances, on the order of one in ten million, the accumulated degraded molten thermoplastic material may be ejected into a parison, resulting in a solid plastic contaminant. A representative contaminant associated with prior art die pins is shown in FIG. 1A, and a comparative infrared spectroscopy analysis of the contaminant and of a finished container is shown in FIG. 1B. The contaminant has an irregular appearance with a brown and black color, and spectroscopic and melting point analyses confirm the contaminant is composed of degraded thermoplastic material of the same polymer composition as the finished container.

To prevent container contamination associated with prior art die pins, it may be necessary to undertake laborious and expensive measures, including periodic phase resets to dislodge the contaminants and line shutdown to permit cleaning of the tooling. However, such efforts are time-consuming and costly, and further require line shutdown, resulting in reduced output. Line shutdown is also associated with increased energy consumption, as the molten plastic must be reheated upon restart.

Accordingly, there is a need for a method and system capable of minimizing the undesirable accumulation of thermoplastic material in extrusion equipment.

### SUMMARY OF INVENTION

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

In one aspect of the disclosed subject matter, a die pin for extrusion of molten plastic is provided. The die pin comprises a base portion, a metallic core member extending from the base portion, and a ceramic head member mounted on the core pin. The ceramic head member has a mounting cavity therein, and the core member has a dimension less than the corresponding dimension of the mounting cavity to allow thermal expansion of the core member therein. The ceramic head member can be made of a ceramic selected from alumina ceramic or zirconia ceramic, and particularly high purity aluminum oxide or ytrria stabilized zirconium oxide.

In accordance with another aspect, an apparatus for extrusion of molten plastic is provided comprising a die ring having an inner surface defining an extrusion opening with a central axis, and a die pin disposed within the extrusion opening and aligned with the central axis, the die pin comprising a base portion, a metallic core member extending from the base portion, and a ceramic head member mounted on the core member, wherein an annular space is defined between an outer surface of the ceramic head member and the inner surface of the die ring. Additionally, a method for extrusion of molten plastic is provided comprising providing an extrusion apparatus comprising a die ring having an inner surface defining an extrusion opening with a central axis, and a die pin disposed within the extrusion opening and aligned with the central axis, the die pin comprising a base portion, a metallic core member extending from the base portion, and a ceramic head member mounted on the core member, wherein an annular space is defined between an outer surface of the ceramic head member and the inner surface of the die ring. The method includes directing molten plastic through the annular space between the die ring and the die pin without accumulation of the molten plastic on the die pin.

It is to be understood that both the foregoing description and the following detailed description are exemplary and are intended to provide further explanation of the disclosed subject matter claimed.

The accompanying drawings, which are incorporated and constitute part of this specification, are included to illustrate and provide a further understanding of the systems of the disclosed subject matter. Together with the description, the drawings serve to explain the principles of the disclosed subject matter. The exemplified embodiments of the disclosed subject matter are not intended to limit the scope of the claims.

### BRIEF DESCRIPTION OF DRAWINGS

The disclosed subject matter will now be described in conjunction with the accompanying drawings in which:

FIG. 1A is a photograph of a degraded plastic contaminant associated with prior art die pins, and FIG. 1B is an infrared spectroscopy analysis of the degraded plastic contaminant shown in FIG. 1A and a reference infrared spectroscopy analysis of the plastic material of a corresponding container.

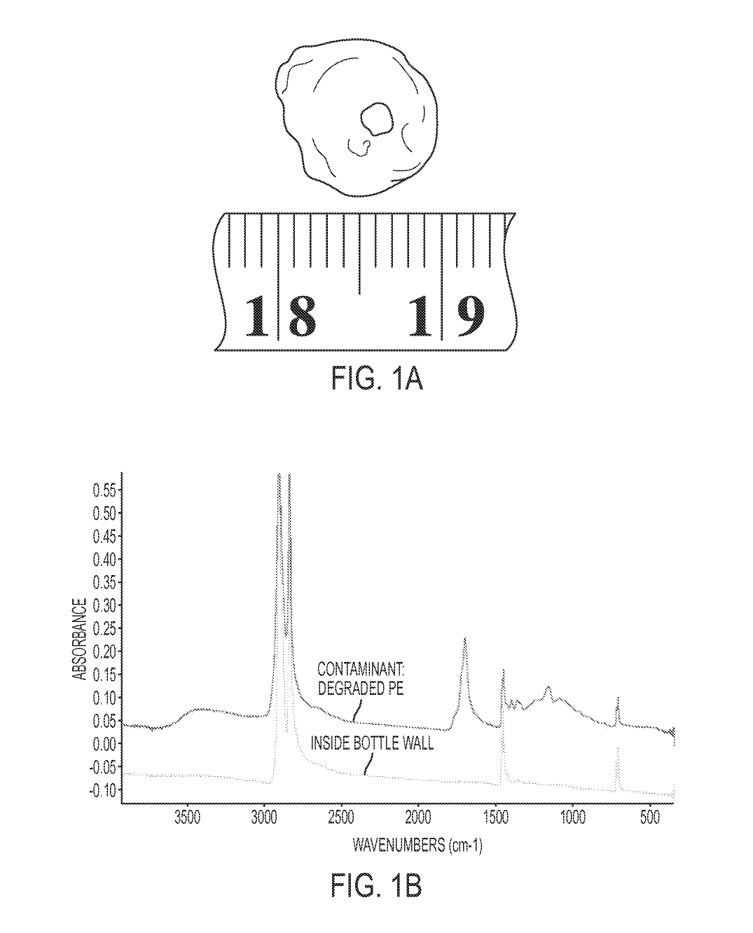

FIG. 2A is a side view of an exemplary embodiment of a pin base member for a die pin according to the present disclosure, and FIG. 2B is a side view of a representative embodiment of a ceramic head member for use with the pin base member of FIG. 2A.

FIG. 3 is a photograph of one embodiment of a ceramic die pin made from the pin base member depicted in FIG. 2A and the ceramic head member depicted in FIG. 2B according to the present disclosure.

FIG. 4 is a schematic illustration of an extrusion blow molding apparatus suitable for use with the die pins of the disclosed subject matter.

### DETAILED DESCRIPTION

Reference will now be made in detail to the various aspects of the disclosed subject matter. The method of the disclosed subject matter will be described in conjunction with the detailed description of the system, the figures and examples provided herein.

Unless otherwise defined, all technical and scientific terms used herein have the same meanings as commonly understood by one of ordinary skill in the art to which the disclosed subject matter belongs. Although methods and materials similar or equivalent to those described herein can be used in its practice, suitable methods and materials are described below.

It is to be noted that the term “a” entity or “an” entity refers to one or more of that entity. As such, the terms “a”, “an”, “one or more”, and “at least one” can be used interchangeably herein. The terms “comprising,” “including,” and “having” can also be used interchangeably. In addition, the terms “amount” and “level” are also interchangeable and can be used to describe a concentration or a specific quantity. Furthermore, the term “selected from the group consisting of” refers to one or more members of the group in the list that follows, including mixtures (i.e. combinations) of two or more members.

The term “about” or “approximately” means within an acceptable error range for the particular value as determined by one of ordinary skill in the art, based upon the technique used to measure the value, i.e., the limitations of the measurement system. For example, “about” can mean within 3 or more than 3 standard deviations, per the practice in the art. Alternatively, “about” can mean a range, for example, of up to +/−20%, or up to +/−10%, or up to +/−5%, or up to +/−1% of a given value.

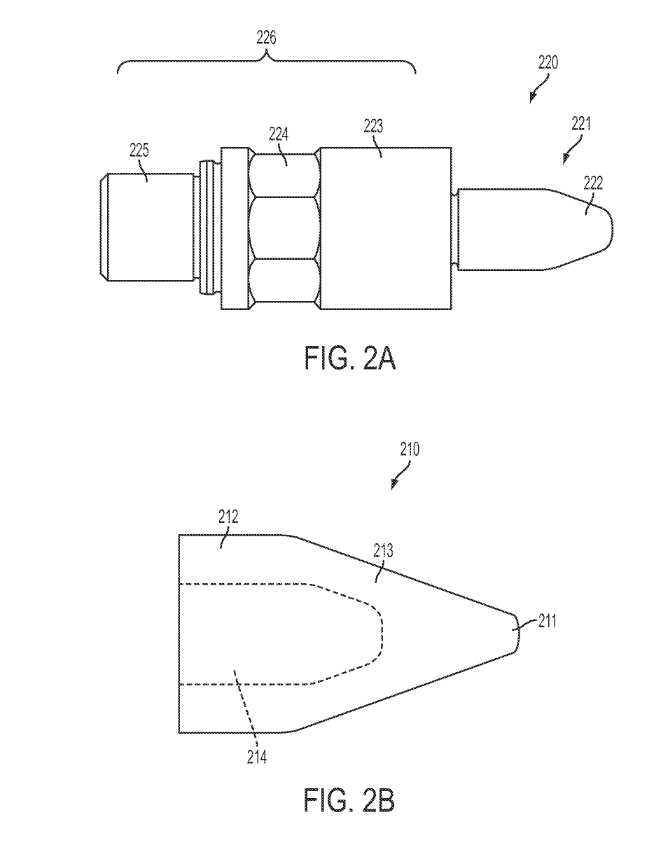

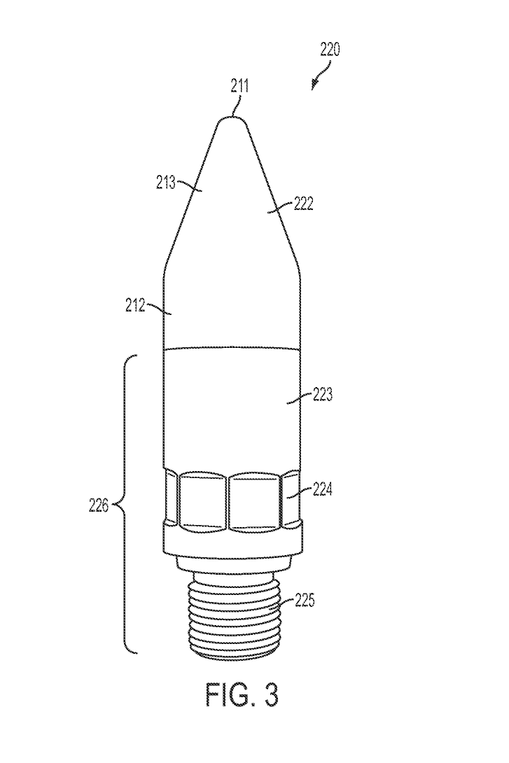

In accordance with one aspect of the present disclosure, a die pin is provided for extrusion of molten plastic. The die pin disclosed herein comprises a base portion, a metallic core member extending from the base portion, and a ceramic head member mounted on the core member is provided. The base portion and the core member together define a pin base member. For purpose of illustration and not limitation, an exemplary embodiment of the disclosed subject matter is depicted in FIGS. 2A, 2B, and 3, comprising a ceramic head member 210 and a pin base member 220. Particularly, FIG. 2A is a side view of a representative embodiment of a pin base member 220 for the die pin, FIG. 2B is a side view of a representative embodiment of a ceramic head member 210 to be mated to the base member, and FIG. 3 is a photograph of a representative embodiment of an assembled die pin 200. As embodied herein, the pin base member 220 includes a base portion 226 and a metallic core member 221 extending from the base portion 226. Particularly, as depicted, the base portion has a generally cylindrical body 223 with a fastener region 225 extending therefrom, such as a threaded portion or the like to be coupled with a mounting portion of an extrusion apparatus. The base portion 226 depicted herein further includes a polygonal region 224 to facilitate a conventional tool to rotatably engage the fastener region 225 with the mounting portion. Although cylindrical body 223 is depicted for the base portion 226, other suitable structure or shapes can be provided if needed.

The fastener region 225 is configured to be compatible with the die stem of the flow head tooling of an existing extrusion apparatus. For example, and as depicted in the exemplary embodiment of FIG. 2A, fastener region 225 has a thread for fixedly engaging a flow head tooling. As embodied herein, a series of curved recesses (i.e. fillets) and flat and beveled surfaces are disposed between the cylindrical member 223 and the fastener region 225. In the exemplary embodiment illustrated, the fastener region 225 has a length of about 1.125 inches and a diameter of about 1 inch along the threaded portion, although any suitable dimensions can be used, as determined by the flow head tooling to which the die pin is to be mounted.

The pin base member, and particularly the base portion, can have any suitable size and shape as required for the intended purpose. As noted above, in some embodiments, including the embodiment illustrated in FIG. 2A, the base portion 226 includes a cylindrical body 223. In the exemplary embodiment depicted in FIG. 2A, the base portion generally has a cylindrical body 223 with an overall diameter of about 1.5 inches, and a total length of about 3.25 inches. Furthermore, and as embodied herein as depicted in FIG. 2A, the base portion 226 can include the polygonal region 224, which is adapted to permit fixing or mounting of the die pin onto the flow head tooling such as by a wrench. The base portion 226 can have any suitable shape and size, which will be determined primarily by the extrusion apparatus and the dimensions of the parison to be extruded

Additionally, and as depicted herein, the pin base member 220 includes a core member 221 extending from the base portion 226. The core member has a free end 222 opposite the base portion 226. As embodied herein, the free end 222 of the core member 221 has a tapered shape, such as a frustroconical shape with a rounded tip as shown. Alternative shapes for the core member likewise can be used as described further below.

In the exemplary embodiment depicted in FIG. 2A, the base portion 220 includes core member 221 formed as a monolithic single-piece structure. In alternative embodiments, the metallic core member can be separately formed and incorporated onto the base portion by any suitable means, including, without limitation, threading, welding, or the like. For example, and in certain embodiments, the base portion can further comprise a mounting cavity (not shown) for the core member, which can be bonded or threadingly engaged to the base portion. The base portion and the core member can be composed of any suitable material, including metal, ceramic, or plastic. In certain embodiments, including the embodiment depicted in FIG. 2A, the base portion and the core member are each composed of tool steel and are formed as a single-piece structure.

As previously noted, the die pin of the disclosed subject matter further includes a ceramic head member to be mounted on the core member of the pin base member. In the exemplary embodiment depicted in FIG. 2B, ceramic head member 210 has cylindrical base portion 212 with a generally uniform diameter over a first length and frustroconical tapered end portion 213 over a second length proximate to the tip 211. The ceramic head member 210 can have any suitable dimension and shape as needed for its intended use. For example, in alternative embodiments, the ceramic head member can have a substantially cylindrical shape with a rounded tip or a hemispherical tip, or a substantially frustroconical shape along the entire length of the head member. Additionally, the relative dimensions of the ceramic head member can be selected as desired. For example, the ceramic head member embodied herein for use with the pin base member of FIG. 2A has an overall length of about 2.5 inches and an overall diameter of about 1.25 inches. Generally, the shape and dimensions of the various embodiments of the die pin disclosed herein are primarily determined by the dimensions of the parison to be extruded and the extrusion apparatus to be used. Furthermore, the overall shape and dimensions of the die pin once assembled can be substantially the same as prior art tool steel die pins, familiar to those of ordinary skill in the art.

In some embodiments, cylindrical body 223 of the base portion 226 will have the same outer diameter as the cylindrical base portion 212 of ceramic head member 210, which is mounted flush against the cylindrical member 223 such that the die pin 200 has a substantially continuous exterior surface. For purpose of illustration and not limitation, an exemplary die pin according to one aspect of the present disclosure is shown in FIG. 3. In accordance with the disclosed subject matter, the die pin comprises a base portion, a metallic core member extending from the base portion, and a ceramic head member mounted on the metallic core member. As shown in the exemplary embodiment depicted in FIG. 3, at least a portion of the ceramic head member is cylindrical and flush with the base portion to form a substantially continuous exterior surface of the die pin.

Additionally, in accordance with the present disclosure, the ceramic head member has a mounting cavity formed therein. For example, and as embodied in FIG. 2B, the internal mounting cavity 214 can have a substantially cylindrical first length and a tapered second length. In alternative embodiments, the internal mounting cavity is substantially cylindrical along the entire length. In some embodiments, the dimensions and shape of the internal mounting cavity are substantially complementary to the dimensions and shape of the metallic core member 221. For example, and with reference to the exemplary embodiment illustrated in FIG. 2A, as noted above, the core member 221 can have a free end 222 opposite the base portion 220, the free end 222 having a frustroconical shape with a rounded tip. In accordance with another aspect of the disclosed subject matter, however, the core member can have at least one dimension less than a corresponding dimension of the mounting cavity to allow thermal expansion of the core member within the mounting cavity. For example, and as embodied herein, and depicted in the exemplary embodiment of FIGS. 2A and 2B, the metallic core member 221 has a dimension or dimensions less than a corresponding dimension or dimensions of the mounting cavity 214 to compensate for thermal expansion of the metallic core when the die pin 200 is heated to a working temperature of up to or even in excess of about 400° F.

In the various embodiments of the present disclosure, the die pin comprises a metallic core member and a ceramic head member mounted on the core member. The ceramic head member embodied herein includes a mounting cavity defined within the proximal surface of the head member which abuts the base portion (i.e., opposite the tip 211). The metallic core member comprises a shape and dimensions for mounting via complementary male-female engagement within the mounting cavity. In certain embodiments, the mounting cavity of the ceramic head member has an internal volume greater than the volume of the metallic core member to allow for thermal expansion of the metallic core member within the cavity of the ceramic head member. Depending on the coefficient of thermal expansion at ambient temperature, the difference between the volume and/or dimension of the mounting cavity and that of the core member can be about 2%, or about 3%, or about 5%, or about 10%, or about 15%, or about 20%, or any value therebetween to ensure that the metallic core member can thermally expand within the mounting cavity without cracking or dislocating the head member. For purpose of illustration and not limitation, a representative linear thermal expansion coefficient for tool steel is 13.0×10⁻⁶ mm/mm/° C., with the corresponding volumetric coefficient being 39.0×10⁻⁶ mm³/mm³/° C. By way of illustration, a tool steel core member mounting projection 10 mm in length and a working temperature of about 400° F. (˜200° C.), will expand by a length of approximately 0.3 mm, or ˜3% of initial length, as it is heated from ambient temperature to working temperature.

In various embodiments, the internal mounting cavity of the ceramic head member can have a diameter of between about 10% and about 60% of the diameter of cylindrical portion 212, and can have a length between about 10% to about 75% of the length of the ceramic head member 210. In one exemplary embodiment, the length of the ceramic head member is 1.5 inches, but can be smaller or greater depending on the flow head tooling and the desired size of the parison. While tip 211 is depicted in FIG. 2B as being rounded, in alternative embodiments the tip is, for example, blunt or flat. In some embodiments, the tip of the ceramic head member is hollow. In alternative embodiments, the tip of the ceramic head member is not hollow.

In certain embodiments, the ceramic head member is mounted onto to the base portion by matingly engaging the mounting cavity of the ceramic head member and the metallic core member of the base. Additionally or alternatively, the head member can be bonded to the base portion with adhesive or the like. Suitable bonding agents include, by way of example and not limitation, epoxide and acrylate based bonding agents. The ceramic head member can be affixed to the base portion in any other suitable manner. For example, in alternative embodiments, the ceramic head member can comprise an engagement feature within the mounting cavity to engage a corresponding feature on the metallic core member.

As disclosed herein, it was determined that die pins comprising a head member formed of a ceramic are not susceptible to the accumulation of molten thermoplastic material and therefore do not result in container contamination. Without limitation to theory, it is believed that the higher specific heat capacity of the ceramic prevents localized cooling of the pin tip as it is subject to continuous flow of pressurized air during parison formation. The disclosed die pins are therefore believed to be less susceptible to condensation of the molten thermoplastic material on the die pin. Additionally, the ceramic metal itself is believed to be less susceptible to non-covalent (e.g., electrostatic, hydrogen-bonding, and Van der Waals) interactions with the molten thermoplastic material than conventional tool steel pins. The ceramic die pins disclosed herein can be used with existing molten thermoplastic extrusion apparatus.

In accordance with one aspect of the present disclosure, at least the head member of a die pin for molten thermoplastic extrusion is composed of at least one ceramic. As used herein, ceramics refer to inorganic, nonmetallic materials made by the action of heat at temperatures sufficient to cause sintering, solid-state reactions, bonding, or conversion partially or wholly to the glassy state, and include without limitation crystalline oxides, nitrides and carbide materials. Suitable ceramics for use with the present disclosure include, without limitation, alumina-based ceramics, boron-based ceramics, zirconia-based ceramics, and silicon-based ceramics. Alumina based ceramics suitable for use with the present disclosure include, without limitation, alumina oxides having a composition of 90% or greater alumina oxide, including 96% alumina oxide, 99.5% alumina oxide, and 99.8% alumina oxide. Suitable boron-based ceramics include boron nitrides and boron carbides. Suitable silicon-based ceramics include silicon carbides and silicon nitrides. Suitable zirconia based ceramics include zirconia oxides such as magnesia stabilized zirconia, yttria stabilized zirconia, and zirconia toughened alumina.

In accordance with another aspect of the disclosed subject matter, the ceramic material is provided with a relatively smooth surface finish. Depending on the extrusion application, surface finishes of less than about 25 μm (1000 μinch) average roughness (Rₐ) will suitable for the at least one ceramic material component of the die pin. For example, the at least one ceramic material can have a surface finish of between about 0.1 μm Rₐ (i.e. approximately 4 RMS) to about 12.5 μm Rₐ (i.e. approximately 500 RMS). More particularly, the at least one ceramic material can have a surface finish of between about 0.1 μm Rₐ and about 1.6 μm Rₐ (i.e. approximately 64 RMS). Furthermore, the at least one ceramic material can have a surface finish of about 0.1 μm to 0.8 μm Rₐ (i.e. approximately 32 RMS).

The ceramic die pin disclosed herein is suitable for use for extrusion of molten thermoplastic polymers for plastic containers. The die pin is suitable for extrusion of, without limitation, polyethylene, low density polyethylene, high density polyethylene, polyethylene terephthalate, polypropylene, polystyrene, and polyvinylchloride.

In a further aspect of the disclosed subject matter, an apparatus for extrusion of molten thermoplastic material is provided. The apparatus includes a die ring having an inner surface defining an extrusion opening with a central axis and a die pin as described above positioned within the central axis of the extrusion opening. An annular space is thus defined between the outer surface of the ceramic head member and the inner surface of the die ring. Particularly, the die pin comprises a base portion, a metallic core member extending from the base portion, and a ceramic head member mounted on the core member.

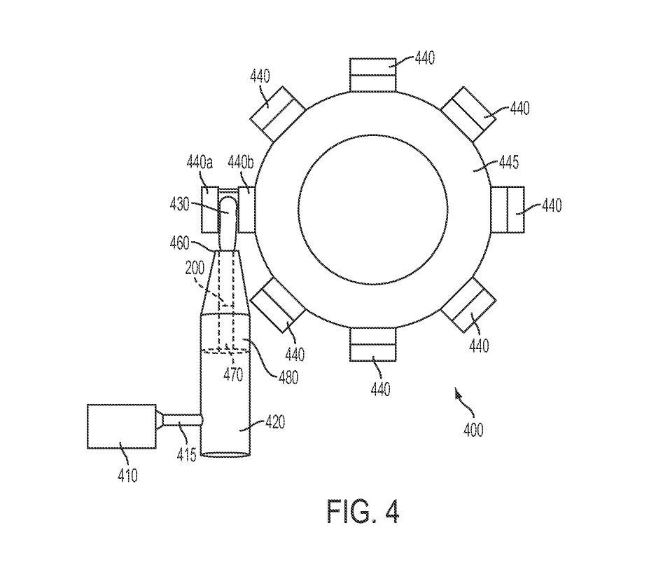

An exemplary extrusion blow molding apparatus suitable for use with the disclosed die pin is shown schematically in FIG. 4 for purpose of illustration. The blow molding apparatus 400 depicted herein, for example, is an upward extruding blow molding apparatus as disclosed in U.S. Pat. No. 8,388,333, the contents of which are incorporated herein in their entirety by reference herein. Generally, the apparatus includes an inflow 410 and melt pipe 415 connected to an extruder having a flow head 420. The molten plastic is extruded outward to form a parison 430 which is captured by a mold 440 with mold halves 440a and 440b. The mold 440 can travel on a wheel 445. In the interior of the flow head a mandrel 470 is present having a die stem which can be actuated up and down, for example, by a servo actuator. A spacer 480 is additionally provided. A die pin 200 in accordance with the description above is operably connected to the die stem. The die pin 200 is positioned within the central axis of extrusion opening 460 of the flow head 420. The molten thermoplastic material flows over the die pin 200 to create the inner diameter of the parison 430 and past the extrusion opening 460 to create the outer diameter of the parison 430. The parison 430 is thus formed from the molten thermoplastic material in the flow head 420, and the parison 430 continuously flows upward from the flow head 420 into the mold 440, where the molten thermoplastic is blown into a desired shape.

Although reference is made, for purpose of illustration and not limitation, to an extrusion apparatus having an upward extruding blow molding configuration, any suitable extrusion configuration using a die pin can be used in accordance with the disclosed subject matter.

In an additional aspect, a method of extruding molten thermoplastic material using a ceramic die pin according to any aspect of the foregoing disclosure is provided. The method disclosed herein includes providing an extrusion apparatus comprising a die ring having an inner surface defining an extrusion opening with a central axis and a die pin disposed within the extrusion opening and aligned with the central axis, such that an annular space is defined between an outer surface of the ceramic head member and the inner surface of the die ring. The method further includes directing molten plastic through the annular space between the die ring and the die pin without accumulation of the molten plastic on the die pin. The die pin provided comprises a base portion, a metallic core member extending from the base portion, and a ceramic head member mounted on the core member. For example, and as embodied herein, with reference to FIG. 4, the method comprises providing an extrusion apparatus comprising a die ring having an inner surface defining an extrusion opening 460 with a central axis and a die pin 200 disposed within the extrusion opening and aligned with the central axis, the die pin 200 comprising a base portion, a metallic core member extending from the base portion, and a ceramic head member mounted on the core member, wherein an annular space is defined between an outer surface of the ceramic head member of die pin 200 and the inner surface of the extrusion opening 460 of the die ring. The method further comprises directing molten plastic through the annular space between the die ring and the die pin without significant accumulation (e.g., accumulation sufficient to result in contamination) of the molten plastic on the die pin. In additional embodiments, the method comprises contacting a ceramic die pin with molten thermoplastic material in an extrusion apparatus. Additional aspects of the method of extrusion can be determined from U.S. Pat. No. 8,388,333, which is incorporated by reference herein.

Due to the higher shear modulus of ceramics relative to tool steel, and in accordance with an additional aspect, the tooling incorporating a ceramic die pin can be subject to an extended heat soak upon line restart to ensure no unmelts are present in the thermoplastic material for extrusion. Unmelts can exert high shear stress on the ceramic head member and can thereby fracture the ceramic head member of the die pin. By thoroughly remelting the thermoplastic material present from the previous run which had cooled and by heating the tooling to the temperature of the molten thermoplastic material, e.g., 260° C. for PET, prior to extrusion, unmelts and associated pin fracture can be prevented. The duration of the heat soak will depend primarily on the specific tooling apparatus being employed. In certain embodiments, a heat soak of at least twenty minutes prior to extrusion is employed, although a heat soak of up to about 80 and even up to about 210 minutes can be employed.

In addition to the specific embodiments claimed below, the disclosed subject matter is also directed to other embodiments having any other possible combination of the dependent features claimed below and those disclosed above. As such, the particular features disclosed herein can be combined with each other in other manners within the scope of the disclosed subject matter such that the disclosed subject matter should be recognized as also specifically directed to other embodiments having other possible combinations. Thus, the foregoing description of specific embodiments of the disclosed subject matter has been presented for purposes of illustration and description. It is not intended to be exhaustive or to limit the disclosed subject matter to those embodiments disclosed.

The disclosed subject matter can be embodied in other specific forms without departing from its spirit or essential characteristics. The described embodiments are to be considered in all respects only as illustrative and not restrictive. Thus, it is intended that the disclosed subject matter include modifications and variations that are within the scope of the appended claims and their equivalents. All references recited herein are incorporated herein in their entirety by specific reference.

1. A die pin for extrusion of molten plastic comprising:
a base portion;
a metallic core member extending from the base portion; and
a ceramic head member mounted on the core member.

2. The die pin of claim 1, wherein the base portion and the core member are made as a monolithic single-piece structure.

3. The die pin of claim 1, wherein the core member comprises tool steel.

4. The die pin of claim 1, wherein the ceramic head member has a mounting cavity formed therein, the core member having a dimension less than a corresponding dimension of the mounting cavity to allow thermal expansion of the core member therein.

5. The die pin of claim 4, wherein the dimension of the core member is about 2% to about 20% less than the corresponding dimension of the mounting cavity.

6. The die pin of claim 1, wherein the core member has a free end opposite the base portion, the free end having a tapered shape.

7. The die pin of claim 6, wherein the free end has a generally frustroconical shape with a rounded tip.

8. The die pin of claim 1, wherein ceramic head member comprises alumina ceramic or zirconia ceramic.

9. The die pin of claim 8, wherein the zirconia ceramic is high purity aluminum oxide.

10. The die pin of claim 1, wherein the ceramic head member has an outer surface finish of between about 4 RMS and about 275 RMS.

11. The die pin of claim 1, wherein the ceramic head member has a tapered shape.

12. The die pin of claim 11, wherein the ceramic head member includes a cylindrical base portion and a frustroconical end portion.

13. The die pin of claim 11, wherein the ceramic head member has a hollow tip.

14. An apparatus for extrusion of molten plastic comprising:
a die ring having an inner surface defining an extrusion opening with a central axis; and
a die pin disposed within the extrusion opening and aligned with the central axis, the die pin comprising
a base portion,
a metallic core member extending from the base portion, and
a ceramic head member mounted on the core member;
wherein an annular space is defined between an outer surface of the ceramic head member and the inner surface of the die ring.

15. The die pin of claim 14, wherein the ceramic head member has a mounting cavity formed therein, the core member having a dimension less than a corresponding dimension of the mounting cavity to allow thermal expansion of the core member therein.

16. The die pin of claim 14, wherein ceramic head member comprises zirconia ceramic.

17. The die pin of claim 14, wherein the ceramic head member has an outer surface finish of between about 4 RMS and about 275 RMS.

18. A method for extrusion of molten plastic comprising:
providing an extrusion apparatus comprising
a die ring having an inner surface defining an extrusion opening with a central axis; and
a die pin disposed within the extrusion opening and aligned with the central axis, the die pin comprising
a base portion,
a metallic core member extending from the base portion, and
a ceramic head member mounted on the core member;
wherein an annular space is defined between an outer surface of the ceramic head member and the inner surface of the die ring; and
directing molten plastic through the annular space between the die ring and the die pin without accumulation of the molten plastic on the die pin.

19. The method of claim 18, further comprising heating the die pin prior to directing molten plastic through the annular space for thermal expansion of the core pin within a mounting cavity formed within the ceramic head member.

20. The method of claim 19, wherein the die pin is heated to about 400° F.
